(19) United States
(12) Patent Application Publication
(10) Pub. No.: US 2014/0177538 A1
(43) Pub. Date: Jun. 26, 2014

(54) LOAD BALANCING AND INTER-CELL INTERFERENCE COORDINATION FOR HETERORGENEOUS NETWORKS

(71) Applicant: ALCATEL-LUCENT USA INC., Murray Hill, NJ (US)

(72) Inventor: Sivarama K. Venkatesan, Milltown, NJ (US)

(73) Assignee: Alcatel-Lucent USA, Inc., Murray Hill, NJ (US)

(21) Appl. No.: 13/724,515

(22) Filed: Dec. 21, 2012

(51) Int. Cl. H04W 72/04

(52) U.S. Cl. CPC H04W 72/0486
USPC 370/329

(57) ABSTRACT

Embodiments of the claimed subject matter provide a method and apparatus performing inter-cell load-balancing and inter-cell interference coordination. Some embodiments of the method include partitioning cells into groups that include a different subset of the plurality of cells. Embodiments of the method also include iteratively repeating, until a convergence criterion is satisfied, steps that include determining one or more associations of user equipment to one or more cells for a previously determined allocation of resources to the groups and determining the allocation of resources to the groups for a previously determined association of user equipment to the cells.

### CROSS REFERENCE TO RELATED APPLICATIONS

This application claims priority to U.S. Provisional Patent Application 61/695,438 filed on Aug. 31, 2012, which is incorporated by reference herein in its entirety.

### BACKGROUND

This application relates generally to communication systems, and, more particularly, to wireless communication systems.

Wireless communication systems include a network of devices for providing wireless connectivity to wireless-enabled devices including mobile units, smart phones, tablet devices, laptops, desktops, and other types of user equipment. Network architectures generally fall into two broad categories: hierarchical and distributed. Hierarchical network architectures used centralized entities to handle mobility management and radio resource control. For example, in conventional hierarchical communications, a server transmits voice and/or data signaling destined for a target access terminal to a central element such as such as a Radio Network Controller (RNC). The RNC may then transmit paging messages to the target access terminal via one or more access nodes to locate the target access terminal. The target access terminal may establish a communication link to one or more of the access nodes in response to receiving the page from the network. A radio resource management function within the RNC receives the voice and/or data signaling and coordinates the radio and time resources used by the set of access nodes to transmit the information to the target access terminal. The radio resource management function can perform fine grain control to allocate and release resources for broadcast transmission over a set of access nodes.

In contrast, a distributed network includes access points that implement distributed communication network functionality. For example, each distributed access point may combine part or all of the RNC and/or Packet Data Serving Node (PDSN) functions in a single entity that manages radio links between one or more access terminals and an outside network, such as the Internet. Distributed access points may implement proxy functionality that utilizes core network element support to equivalent IP functions. For example, IP anchoring in a UMTS base station router may be offered through a Mobile IP Home Agent (HA) and the Gateway GPRS Support Node (GGSN) anchoring functions that the base station router proxies through equivalent Mobile IP signaling. Compared to hierarchical networks, distributed architectures have the potential to reduce the cost and/or complexity of deploying the network, as well as the cost and/or complexity of adding additional access points to expand the coverage of an existing network. Distributed networks may also reduce (relative to hierarchical networks) the delays experienced by users because packet queuing delays at the RNC and PDSN of hierarchical networks may be reduced or removed.

At least in part because of the reduced cost and complexity of deploying a base station router, base station routers may be deployed in locations that are impractical for conventional base stations. For example, a base station router may be deployed in a residence or building to provide wireless connectivity to the occupants of the residence or the building. Base station routers deployed in a residence are typically referred to as home base station routers or femtocells because they are intended to provide wireless connectivity to a small area that encompasses a residence, e.g, an area of approximately a few hundred square meters. Home base station routers may also be referred to as microcells, picocells, small cells, and the like. However, the functionality in a home base station router is typically quite similar to the functionality implemented in a conventional base station router that is intended to provide wireless connectivity to an area of approximately several square kilometers or more. One important difference between a home base station router and a conventional base station router is that home base station routers are designed to be plug-and-play devices that can be purchased off-the-shelf and easily installed by a lay person.

As communication networks grow and evolve, they incorporate numerous types and generations of wireless communication systems that provide network connectivity according to different standards and/or protocols. Networks that implement different types of access devices that operate according to different standards and/or protocols are typically referred to as heterogeneous networks. Exemplary heterogeneous networks include systems that provide wireless connectivity using femtocells, microcells, or picocells (e.g., systems that provide wireless connectivity according to the IEEE 802.11, IEEE 802.15, or Wi-Fi standards) and systems that provide wireless connectivity using macrocells (e.g., systems that operate according to the Third Generation Partnership Project standards—3GPP, 3GPP2—and/or systems operate according to the IEEE 802.16 and IEEE 802.20 standards). Multiple generations of these systems have been deployed including Second Generation (2G), Third Generation (3G), and Forth Generation (4G) standards.

### SUMMARY OF EMBODIMENTS

The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

As discussed herein, some embodiments of heterogeneous cellular networks may include conventional base stations or base station routers that provide wireless connectivity to comparatively large geographic regions that are referred to as macrocells. The heterogeneous cellular network may also include other access points that provide wireless connectivity to relatively smaller geographic regions (e.g., femtocells, picocells, or microcells) that overlay the macrocells so that their coverage areas intersect or overlap the coverage areas of the macrocells. The base stations or base station routers may be referred to as macrocells and the overlaying access points may be referred to as picocells. The macrocells and the picocells can interfere with each other and so conventional heterogeneous cellular networks implement inter-cell interference coordination. For example, the downlink air interface resources may be partitioned in the time domain by specifying almost-blank subframes during which the macrocells minimize transmission to reduce interference to nearby picocells, which then make scheduling decisions based on knowledge of the time partitioning. Heterogeneous networks also attempt to balance loads between the macrocells and picocells using a cell-specific association bias. For example, each macrocell or picocell can bias measured values of the downlink signal-to-noise ratio (SNR) by a selected amount. The biased SNR can then be used to select a serving macrocell or picocell.

Conventional heterogeneous networks treat the inter-cell interference coordination and load balancing problems independently. However, in actual deployments, the inter-cell interference coordination problem and the load balancing problem are coupled problems. For example, the interference received at a picocell due to downlink transmissions from a macrocell depends on parameters such as the number of user equipment served by the macrocell and a fraction of time allocated to the downlink transmissions from the macrocell. The load on a macrocell (or picocell) also depends on the number of user equipment served by the macrocell (or picocell) and the fraction of time allocated to downlink transmissions. Moreover, stronger inter-cell interference from neighboring macrocells may cause a picocell to increase its downlink power, thereby increasing the load on the picocell and increasing the inter-cell interference generated by the picocell's downlink transmission. Solving these problems independently therefore leads to a suboptimal solution. Moreover, extensive off-line simulations are needed to estimate the bias values for inter-cell load-balancing and the time domain partitioning for inter-cell interference coordination. The offline simulations are used to generate static settings for the inter-cell load-balancing and interference coordination parameters, which does not allow dynamic adaptation to instantaneous traffic and channel conditions. Although these problems may be especially acute in heterogeneous networks, the aforementioned problems may arise in any cellular wireless access network. The disclosed subject matter is directed to addressing the effects of one or more of the problems set forth above.

In one embodiment, a method is provided for performing inter-cell load-balancing and inter-cell interference coordination. Some embodiments of the method include partitioning cells into groups that include different subsets of the cells. Embodiments of the method also include iteratively repeating, until a convergence criterion is satisfied, steps that include determining one or more associations of user equipment to one or more of the cells for a previously determined allocation of resources to the groups and determining the allocation of resources to the groups for a previously determined association of user equipment to the cells.

In another embodiment, an apparatus is provided for implementing inter-cell load-balancing and inter-cell interference coordination algorithm. Some embodiments of the apparatus include a controller configured to partition cells into groups that include different subsets of the cells. The controller is configured to iteratively repeat, until a convergence criterion is satisfied, steps including determining one or more associations of user equipment to one or more of the cells for a previously determined allocation of resources to the groups and determining the allocation of resources to the groups for a previously determined association of user equipment to the cells.

In yet another embodiment, non-transitory computer-readable storage medium encoded with instructions that, when executed by a processing device, adapt the processing device to perform a method for inter-cell load-balancing and inter-cell interference coordination. Some embodiments of the non-transitory computer-readable storage medium are encoded with instructions that adapt the processing device to partition cells into groups that include different subsets of the cells. Some embodiments of the non-transitory computer-readable storage medium are encoded with instructions for iteratively repeating, until a convergence criterion is satisfied, steps including determining one or more associations of user equipment to one or more of the cells for a previously determined allocation of resources to the groups and determining the allocation of resources to the groups for a previously determined association of user equipment to the cells.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates one exemplary embodiment of a wireless communication system;

FIG. 2 conceptually illustrates one exemplary embodiment of an allocation of time for downlink transmissions by two groups of cells;

FIG. 3 conceptually illustrates one exemplary embodiment of an assignment of users to sub-bands for downlink transmission during an allocated time interval;

FIG. 4 conceptually illustrates one exemplary embodiment of a method for solving the coupled inter-cell interference coordination and load balancing problems for a heterogeneous network, such as the wireless communication system depicted in FIG. 1;

FIG. 5 conceptually illustrates one exemplary embodiment of a method for determining user-to-cell assignments assuming fixed cell group time fractions using a suboptimal greedy algorithm; and

FIG. 6 conceptually illustrates one exemplary embodiment of a method of determining cell group time fractions assuming fixed user-to-cell assignments.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. The description and drawings merely illustrate the principles of the claimed subject matter. It should thus be appreciated that those skilled in the art may be able to devise various arrangements that, although not explicitly described or shown herein, embody the principles described herein and may be included within the scope of the claimed subject matter. Furthermore, all examples recited herein are principally intended to be for pedagogical purposes to aid the reader in understanding the principles of the claimed subject matter and the concepts contributed by the inventor(s) to furthering the art, and are to be construed as being without limitation to such specifically recited examples and conditions.

The disclosed subject matter is described with reference to the attached figures. Various structures, systems and devices are schematically depicted in the drawings for purposes of explanation only and so as to not obscure the description with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition is expressly set forth in the specification in a definitional manner that directly and unequivocally provides the special definition for the term or phrase. Additionally, the term, “or,” as used herein, refers to a non-exclusive “or,” unless otherwise indicated (e.g., “or else” or “or in the alternative”). Also, the various embodiments described herein are not necessarily mutually exclusive, as some embodiments can be combined with one or more other embodiments to form new embodiments.

As discussed herein, performing inter-cell interference coordination and inter-cell load-balancing independently leads to a suboptimal solution and requires significant off-line simulations or modeling to determine the (static) interference coordination or load-balancing parameters. The present application therefore describes embodiments and techniques that support partitioning the network cells into different groups and then using an iterative process to determine the time intervals allocated for downlink transmissions by the different groups and to associate users with the macrocells or picocells in the different groups. For example, the macrocells or picocells may be partitioned into a first group that includes the macrocells and picocells and a second group that only includes the picocells. User equipment is associated with macrocells or picocells and resources (such as time in a time division multiplexing scheme) are allocated to these groups.

The coupled inter-cell interference coordination and inter-cell load-balancing problems are then solved using an iterative process that includes alternating the steps: (1) determining associations of user equipment with the macrocells or picocells while maintaining a fixed allocation of resources to the groups of cells and (2) allocating the resources to the groups of cells while maintaining a fixed association of user equipment with the macrocells or picocells. For example, user equipment can be initially associated with the macrocells or picocells assuming all the cells are active and transmitting all the time. The determined association of user equipment with macrocells or picocells can then be held fixed and the allocation of resources to the groups of cells can be modified based on inter-cell interference. The modified resource allocation can then be held fixed during a subsequent modification of the association of user equipment with macrocells or picocells. The process is iterated until the association or allocation satisfies a stopping condition.

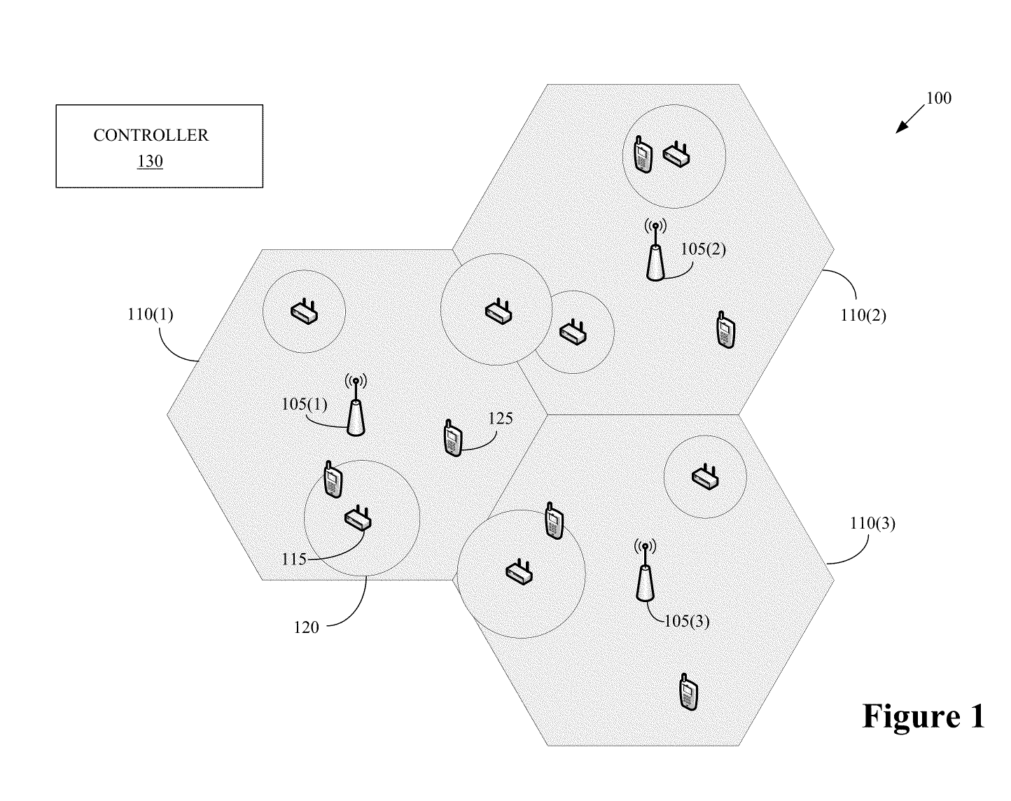

FIG. 1 conceptually illustrates one exemplary embodiment of a wireless communication system 100. In the illustrated embodiment, the wireless communication system 100 includes a plurality of base stations or base station routers 105 that are used to provide wireless connectivity to corresponding geographical areas or cells 110. The base stations or base station routers 105 and the cells 110 may both be referred to as “macrocells” in accordance with common usage in the art. The wireless communication system 100 also includes various access points 115 that provide wireless connectivity to corresponding geographical areas or cells 120. In the interest of clarity, only one access point 115 and cell 120 are indicated by reference numerals in FIG. 1. Exemplary access points 115 may include, but are not limited to, femtocells, microcells, small cells, or picocells. The access points 115 and the cells 120 may both be referred to as “picocells” in accordance with common usage in the art. Persons of ordinary skill in the art should also appreciate that the term “cell” may be used to indicate the device that is used to provide wireless connectivity to a geographic area 110, 120. For example, a base station router 105 may be referred to as a cell 105 and an access point 115 may be referred to as a cell 115.

The macrocells 105 and the picocells 115 shown in FIG. 1 are deployed as a heterogeneous network with overlaying coverage areas so that the cells 110, 120 intersect or overlap with each other. The overlaying macrocells 105 or picocells 105 may provide wireless connectivity to one or more user equipment 125 (also referred to herein as a user in accordance with common usage in the art) (only one indicated by a reference numeral in the interest of clarity). At least in part because of the overlapping coverage areas, user equipment 125 may have the option of being assigned different macrocells 105 or picocells 115. For example, user equipment 125 may fall within a picocell 115 that overlays a corresponding macrocell 110

The wireless communication system 100 also includes a controller 130 that performs functions including allocating resources to the macrocells 105 or the picocells 115, assigning user equipment 125 to the macrocells 105 or the picocells 115 for load balancing purposes, and the like. Some embodiments of the controller 130 are configured to allocate time resources to the macrocells 105 or the picocells 115 for time division multiplexed downlink transmissions. For example, the controller 130 may instruct one or more of the macrocells 105 to limit the time intervals during which the macrocells 105 perform downlink transmissions by instructing one or more of the macrocells 105 to transmit almost blank subframes (ABSs), which are defined as subframes with reduced downlink transmission power or activity. An ABS may be totally blank to remove as much as possible of the interference towards user equipment 125 that are served by picocells 115. However, the transmission and exact content of ABSs is an implementation choice that may take into account factors such as the gains from interference reduction versus the loss of transmission resources from being unable to transmit data in the ABSs.

The controller 130 depicted in FIG. 1 is configurable to iteratively solve the coupled inter-cell load-balancing and inter-cell interference coordination problems. Some embodiments of the controller 130 may therefore partition the macrocells 105 and the picocells 115 into groups that include different combinations of the macrocells 105 or the picocells 115. For example, one group may include all of the macrocells 105 and the picocells 115 and another group may include only the picocells 115. These examples should not be understood as limiting, however, because an analogous framework can be applied to any arbitrary collection of cell groups in some embodiments. That is, the set of cell groups may include any collection of nontrivial subsets of the set Σ of all cells (e.g., the macrocells 105 or the picocells 115) in the network 100.

The controller 130 may then perform load-balancing by assigning the user equipment 125 to the macrocells 105 or the picocells 115 while assuming an initial (or previously determined) allocation of resources to the different groups of macrocells 105 or picocells 115. Exemplary resources include, but are not limited to, time intervals or subframes in a time division multiplexing scheme. The controller 130 may then perform inter-cell interference coordination to allocate the resources to the groups using the previously determined assignment of user equipment 125 to macrocells 105 or picocells 115. For example, the controller 130 may perform inter-cell interference coordination to allocate time intervals or subframes to the groups. The controller 130 can iterate this process until a convergence criterion is satisfied.

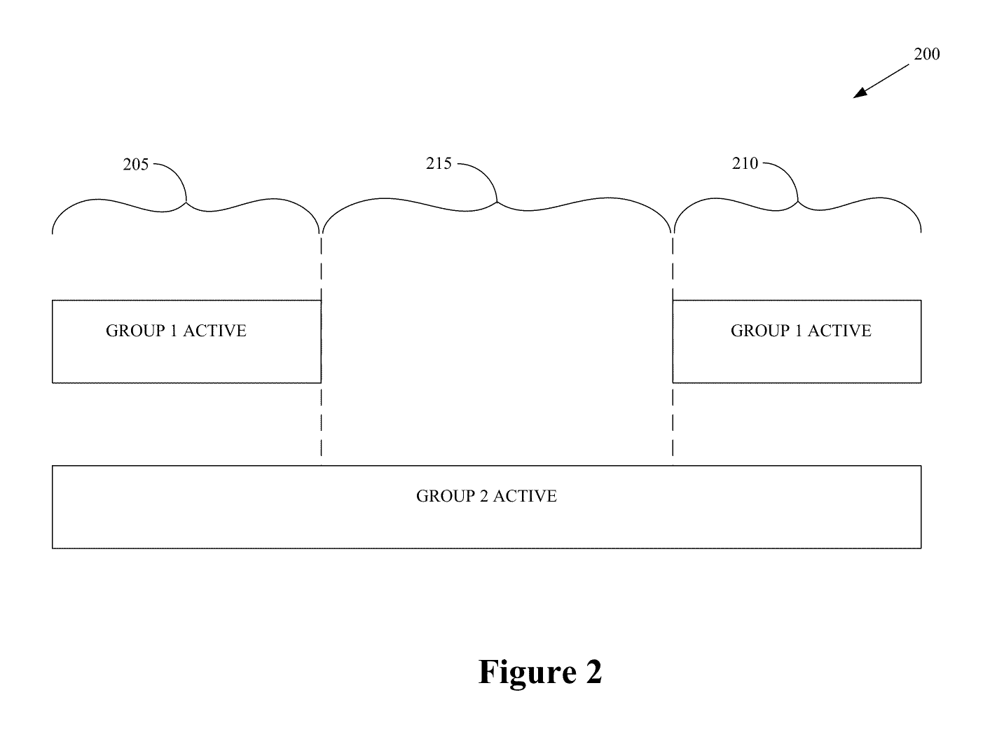

FIG. 2 conceptually illustrates one exemplary embodiment of an allocation 200 of time for downlink transmissions by two groups of cells. Some embodiments of the allocation 200 may be determined by entities in the wireless communication system 100 such as the controller 130 depicted in FIG. 1. The macrocells or picocells in Group 1 and Group 2 are active in the time intervals 205, 210. For example, Group 1 may contain the macrocells in a wireless communication system and Group 2 may include the picocells in a wireless communication system. All of the cells in the wireless communication system (which may include macrocells, picocells, or any other device for providing wireless connectivity to a geographic area) may therefore be active during the time intervals 205, 210 and may perform downlink transmissions to user equipment during the time intervals 205, 210. Group 1 is not active during the time interval 215 and so the cells in Group 1 may not transmit over the downlink during the time interval 215. For example, in embodiments that assign the macrocells of the wireless communication system to Group 1, the macrocells may be instructed to transmit ABSs over the downlink communication channels during the time interval 215. Cells in Group 2 can continue to transmit over the downlink during the time interval 215. As discussed herein, an entity such as a controller may be used to dynamically determine durations of the time intervals 205, 210, 215.

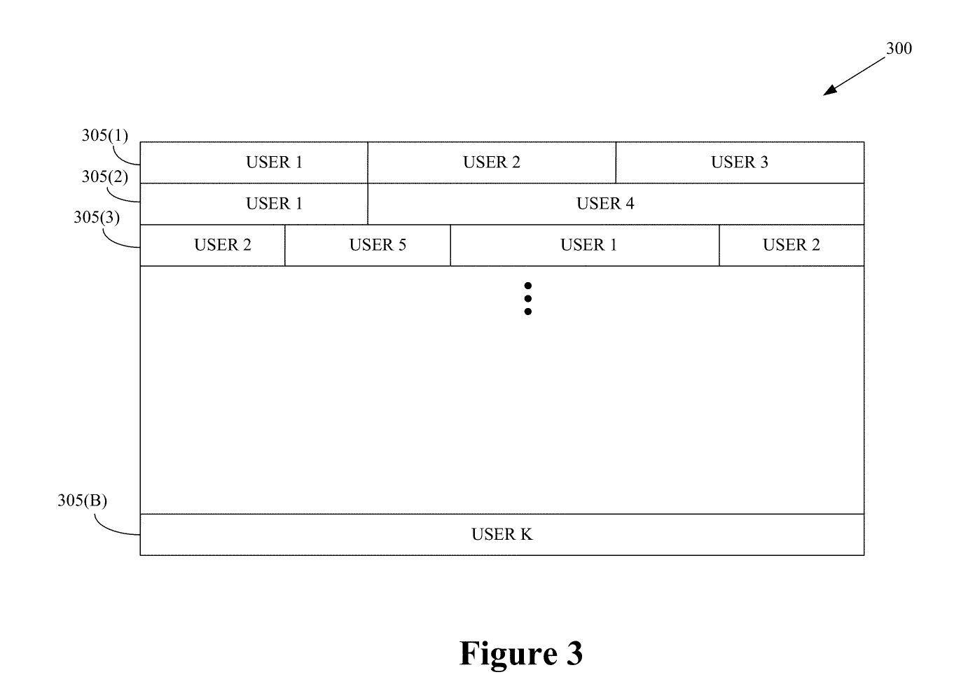

FIG. 3 conceptually illustrates one exemplary embodiment of an assignment 300 of users to sub-bands 305 for downlink transmission during an allocated time interval. For example, the time interval depicted in FIG. 3 may correspond to the time interval 205 shown in FIG. 2 and the assignment 300 depicted in FIG. 3 may correspond to an assignment made by one of the cells in Group 1 or Group 2 for downlink transmissions. The users are allocated to the different sub-bands 305 in accordance with the assignment of users to the corresponding cells, e.g., the user assignments determined by the load-balancing problem discussed herein. For example, a converged solution to the coupled inter-cell interference coordination and load balancing problems may include assigning K users to the cell depicted in FIG. 3. The cell may then schedule the K users to the B sub-bands 305 using a scheduling algorithm implemented by the cell.

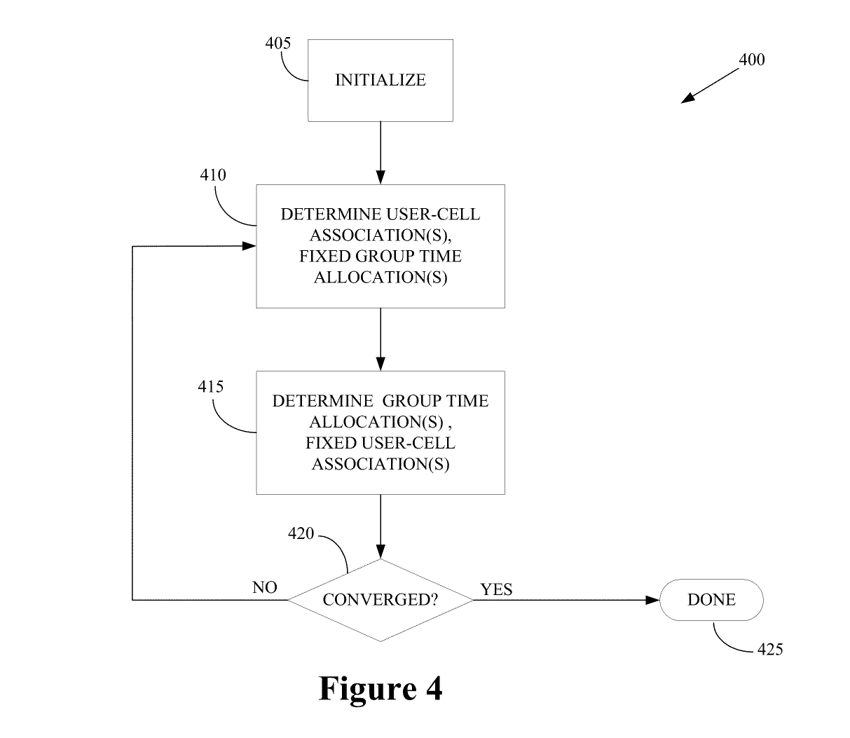

FIG. 4 conceptually illustrates one exemplary embodiment of a method 400 for solving the coupled inter-cell interference coordination and load balancing problems for a heterogeneous network, such as the wireless communication system 100 depicted in FIG. 1. The method 400 depicted in FIG. 4 is an iterative process that alternates between solving an inter-cell interference coordination problem and a load balancing problem. Some embodiments of the method 400 may be implemented in a controller such as the controller 130 depicted in FIG. 1. In the illustrated embodiment, the heterogeneous network implements time division multiplexing and so the iterative process allocates time intervals or time fractions to the cell groups for transmitting signals over a downlink. However, persons of ordinary skill in the art having benefit of the present disclosure should appreciate that alternative embodiments of the method 400 may allocate other resources such as frequencies or tones to the cell groups in addition to or instead of the time intervals or time fractions.

The method 400 begins by initializing (at 405) the objective value (M) of the best feasible solution to −∞. Also, the cell group time fractions { y̅^{(G)}} may be initialized (at 405) to correspond to all cells being active all the time. For example, the cell group time fractions may be initialized so that y̅^{(C)}=1, and y̅^{(G)}=0 for all G≠C, where G indicates a cell group and C is a set of cells in the network that are involved in the optimization. The controller may then determine (at 410) associations or assignments {Ũ_{c}} of user equipment to cells such as the macrocells or picocells shown in FIG. 1 while the cell group time fractions are held fixed at values of { y̅^{(G)}}. The controller determines (at 415) the cell group time fractions that are allocated to each cell group while holding the user-to-cell assignments fixed at {Ũ_{c}}. For example, the controller may determine (at 415) cell group time fractions {\tilde{y}^{(G)}}, user time fractions {\tilde{t}_{u,c}^{(G)}(b)}, and user rates {\tilde{r}ᵤ}. The user time fraction {\tilde{t}_{u,c}^{(G)}(b)} indicates the fraction of time allocated to the user (u) on the sub-band (b) in the cell (c). The user rate {\tilde{r}ᵤ} indicates the overall rate (e.g., in bits per second) achieved by the user (u).

A convergence criterion can then be used to determine whether to continue iterating the process or to terminate the process. Some embodiments of the method 400 use a convex objective function such as the sum of the logarithms of the user rates: Fᵤ(\tilde{r}ᵤ)=log \tilde{r}ᵤ. The convergence criteria indicates that the controller has identified a better feasible solution when

$${\sum }_{u ∈ U} {F}_{u} ( {\tilde{r}}_{u} ) > M .$$

The current solution may then be updated (at 420) from ({Ū_{c}},{ y̅^{(G)}},{ t̅_{u,c}^{(G)}(b)},{ r̅ᵤ}) to ({Ũ_{c}},{\tilde{y}^{(G)}},{\tilde{t}_{u,c}^{(G)}(b)},{\tilde{r}ᵤ}) and M to

$${\sum }_{u ∈ U} {F}_{u} ( {\tilde{r}}_{u} ) .$$

The method 400 then begins another iteration by determining (at 410) the user-cell associations, as discussed herein. If the controller does not identify a better feasible solution, as indicated by the convergence criteria, the method ends (at 425) and the controller may provide the current feasible solution ({Ū_{c}},{ y̅^{(G)}},{ t̅_{u,c}^{(G)}(b)},{ r̅ᵤ}) as the solution to the coupled inter-cell interference and load balancing problems.

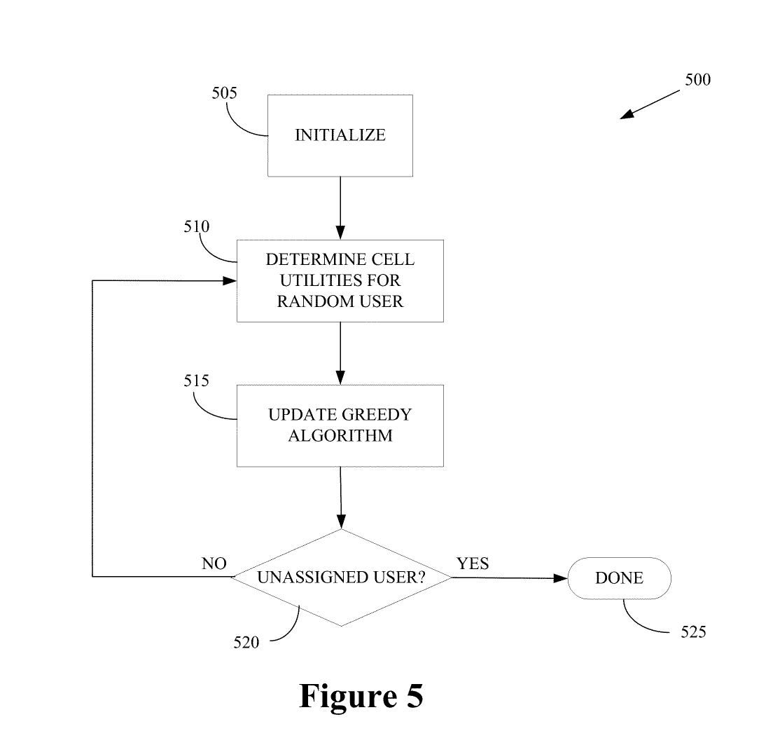

FIG. 5 conceptually illustrates one exemplary embodiment of a method 500 for determining user-to-cell assignments assuming fixed cell group time fractions using a suboptimal greedy algorithm. Some embodiments of the method 500 may be implemented in a controller such as the controller 130 depicted in FIG. 1 and may be used to perform step 410 in embodiments of the method 400 depicted in FIG. 4. There are no users assigned to cells at the beginning of the method 500. The controller may therefore initialize (at 505) the set of allocated cells and current cell utility function M_{c} for each cell. For example, the controller may initialize (at 505) the method 500 by setting set Ũ_{c}←{ } for all cεC and for each cεC, the method 500 may set the cell utility function to M_{c}←0. The quantity M_{c} is the current cell utility for cell c, which represents the sum utility of all users assigned to cell c.

The iterative process depicted in FIG. 5 begins by selecting a random user and determining (at 510) cell utility functions that would result from assigning the random user to different cells. Some embodiments of the method 500 randomly pick a user

$${u}^{*} ∉ {⋃}_{c ∈ C} {\tilde{U}}_{c}$$

that has not already been assigned to a cell. For each cell cεC, the augmented cell utility \hat{M}_{c} may then be determined (at 510) by assuming that user u* assigned to the cell:

$${\hat{M}}_{c} = {max}_{\{ {t}_{u}^{( G )} \} , \{ {r}_{u} \}} {\sum }_{u ∈ {\tilde{U}}_{c} ⋃ \{ {u}^{*} \}} {F}_{u } ( {r}_{u} )$$

subject to

$${t}_{u}^{( G )} ( b ) \geq 0 for all G ∈ Γ such that c ∈ G , \\ u ∈ {\tilde{U}}_{c} ⋃ \{ {u}^{*} \} , b ∈ \{ 1 , 2 , … , B \} ;$$

$${\sum }_{u ∈ {\tilde{U}}_{c} ⋃ \{ {u}^{*} \}} {t}_{u}^{( G )} ( b ) = {\overline{y}}^{( G )} for all G ∈ Γ such that c ∈ G , \\ b ∈ \{ 1 , 2 , … , B \} ;$$

$${r}_{u} {\sum }_{G ∈ Γ \text{:} c ∈ G} {\sum }_{b = 1}^{B} {t}_{u}^{( G )} ( b ) {R}_{u , c}^{( G )} ( b ) for all u ∈ {\tilde{U}}_{c} ⋃ \{ {u}^{*} \} .$$

Some embodiments of this convex problem can be solved (at 510) using the well-known Frank-Wolfe algorithm.

In one embodiment, the Frank-Wolf algorithm can be used to determine (at 510) cell assignments as follows:
a. Initialize tᵤ^{(G)}(b) to (|Ũ_{c}|+1)⁻¹ for all GεΓ such that cεG, uεŨ_{c}∪{u*}, and bε{1,2, . . . , B} (i.e., equal time for all users in each sub-band, for any active cell group). Accordingly, initialize rᵤ to

$${\sum }_{G ∈ Γ \text{:} c ∈ G} {\sum }_{b = 1}^{B} {( \vert {\tilde{U}}_{c} \vert + 1 )}^{- 1} {R}_{u , c}^{( G )} ( b )$$

for each uεŨ_{c}∪{u*}.
b. For each GεΓ such that cεG, uεŨ_{c}∪{u*}, and bε{1,2, . . . , B}, define \hat{t}ᵤ^{(G)}(b) to be 1 if u=û^{(G)}(b), and 0 otherwise; here,

$${\hat{u}}^{( G )} ( b ) = {arg max}_{u ∈ {\tilde{U}}_{c} ⋃ \{ {u}^{*} \}} {F}_{u}^{′} ( {r}_{u} ) {R}_{u , c}^{( G )} ( b )$$

(with ties resolved arbitrarily). Accordingly, let

$${\hat{r}}_{u} = {\sum }_{G ∈ Γ : c ∈ G} {{\sum }_{b = 1}}^{B} {\hat{t}}_{u}^{( G )} ( b ) {R}_{u , c}^{( G )} ( b )$$

for each uεŨ_{c}∪{u*}.
c. Using a simple binary or golden-section line search, compute

$${α}^{*} = {arg max}_{α ∈ [ 0 , 1 ]} {\sum }_{u ∈ {\tilde{U}}_{c} ⋃ \{ {u}^{*} \}} {F}_{u} ( ( 1 - α ) {r}_{u} + α {\hat{ r}}_{u} ) .$$

d. Perform updates tᵤ^{(G)}(b)←(1−α*)tᵤ^{(G)}(b)+α*\hat{t}ᵤ^{(G)}(b) and rᵤ←(1−α*)rᵤ+α*\hat{r}
e. If α* is below a suitably chosen threshold, say, if α*<10⁻³, terminate the algorithm and output

$${\hat{M}}_{c} = {\sum }_{u ∈ {\tilde{U}}_{c} ⋃ \{ {u}^{*} \}} {F}_{u} ( {r}_{u} ) .$$

Otherwise return to Step b and continue.

However, persons of ordinary skill in the art having benefit of the present disclosure should appreciate that alternate approaches may also be used to determine (at 510) cell utilities for assigning users to different cells.

The assignment of users to a cell may then be updated (at 515) by assigning user u* to the cell

$${c}^{*} = {arg max}_{c ∈ C} [ {\hat{M}}_{c} - {M}_{c} ] ,$$

which is the cell whose utility would increase the most from the addition of u*. Ties between cells that received the same increase in utility by adding the user may be resolved arbitrarily. The method 500 may then perform (at 515) the updates of the user assignments Ũ_{c}*←Ũ_{c}*∪{u*} and the cell utility function M_{c}*←\hat{M}_{c}*. If at least one unassigned user remains (at 520), i.e., if

$${⋃}_{c ∈ C} {\tilde{U}}_{c} \neq U ,$$

the iterative process continues by determining (at 510) the cell utilities for another user that is selected randomly from among the remaining (unassigned) users. Otherwise the method ends (at 525).

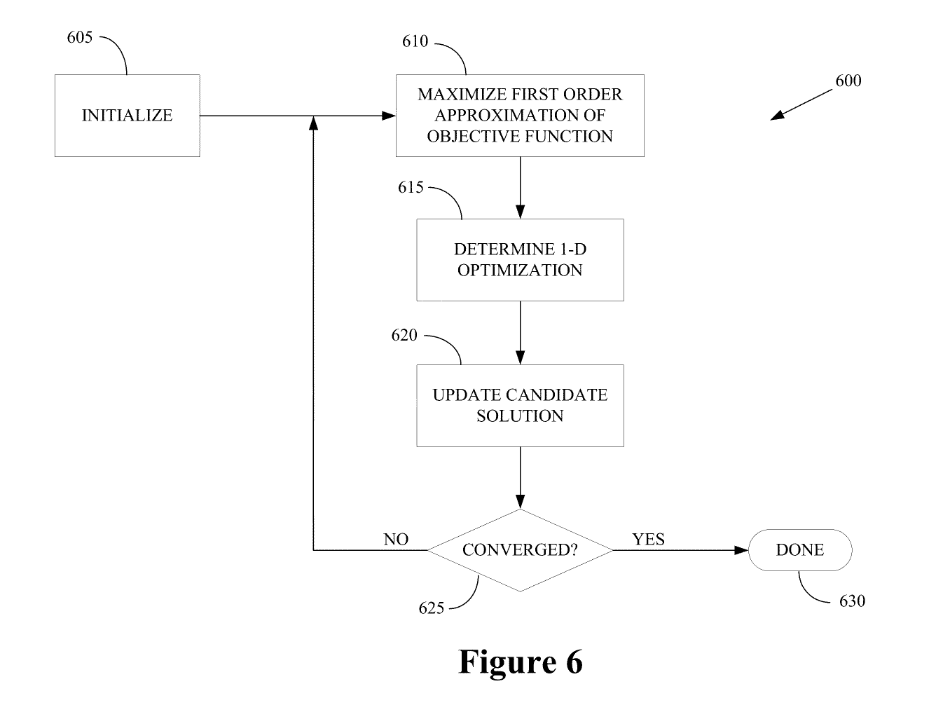

FIG. 6 conceptually illustrates one exemplary embodiment of a method 600 of determining cell group time fractions assuming fixed user-to-cell assignments. Some embodiments of the method 600 may be implemented in a controller such as the controller 130 depicted in FIG. 1 and may be used to perform step 415 in embodiments of the method 400 depicted in FIG. 4. The method 600 determines a solution to the inter-cell interference coordination problem assuming fixed user-to-cell assignments {Ũ_{c}}. Some embodiments of the solution indicate the cell group time fractions {\tilde{y}^{(G)}}, user time fractions {\tilde{t}_{u,c}^{(G)}(b)}, and user rates {\tilde{r}ᵤ} and may be determined using embodiments of the Frank-Wolfe algorithm.

The illustrated embodiment of the method 600 is initialized (at 605) so that all cells are active all the time and each cell allocates equal time to all its assigned users in each sub-band. For example, for each cell group GεΓ, the cell group time fractions may be initialized (at 605) to:

$${\tilde{y}}^{( G )} = \{ \begin{matrix}1 & if G = C ; \\ 0 & otherwise ,\end{matrix}$$

and, for each cell cεG, user uεU, and sub-band bε{1,2, . . . , B},

$${\tilde{t}}_{u , c}^{( G )} ( b ) = \{ \begin{matrix}{\vert {\tilde{U}}_{c} \vert}^{- 1} & if G \text{?} C and u ∈ {\tilde{U}}_{c} , ; \\ 0 & otherwise .\end{matrix} \\ \text{?} \text{indicates text missing or illegible when filed}$$

The resulting initial rate in bits/sec for user uεŨ_{c} is

$${\tilde{r}}_{u} = {\vert {\tilde{U}}_{c} \vert}^{- 1} {\sum }_{b = 1}^{B} {R}_{u , c}^{( C )} ( b ) .$$

The method 600 may then maximize (at 610) a first order approximation of the objective function. For example, the method 600 may determine (at 610) a feasible solution ({ŷ^{(G)}},{\hat{t}_{u,c}^{(G)}(b)},{\hat{r}ᵤ}) that maximizes the first-order approximation

$${\sum }_{u ∈ U} [ {F}_{u} ( {\tilde{r}}_{u} ) + {F}_{u}^{′} ( {\tilde{r}}_{u} ) ( {r}_{u} - {\tilde{r}}_{u} ) ]$$

of the objective function at the current candidate solution ({\tilde{y}^{(G)}},{\tilde{t}_{u,c}^{(G)}(b)},{\tilde{r}ᵤ}). This is a linear program that can be solved by inspection in some embodiments.

The solution determined at 610 corresponds to a single cell group ĜεΓ being active all the time and each cell cεĜ serves a single user û_{c}(b)εŨ_{c} all the time in each sub-band bε{1,2, . . . , B}. In this solution the single cell group may be given by:

$$\hat{G} = {arg max}_{G ∈ Γ} {\sum }_{c ∈ G} {{\sum }_{b = 1}}^{B} {max}_{u ∈ {\tilde{U}}_{c}} [ {F}_{u}^{′} ( {\tilde{r}}_{u} ) {R}_{u , c}^{( G )} ( b ) ] , \\ and$$

$${\hat{u}}_{c} ( b ) = {arg max}_{u ∈ {\tilde{U}}_{c}} {F}_{u}^{′} ( {\tilde{r}}_{u} ) {R}_{u , c}^{( \hat{G} )} ( b ) ,$$

with all ties resolved arbitrarily. Thus, for each cell group GεΓ,

$${\hat{y}}^{( G )} = \{ \begin{matrix}1 & if G = \hat{G} , \\ 0 & otherwise ,\end{matrix}$$

and, for each cell cεG, user uεU, and sub-band bε{1,2, . . . , B},

$${\hat{t}}_{u , c}^{( G )} ( b ) = \{ \begin{matrix}1 & if G \text{?} \hat{G} and u = {\hat{u}}_{c} ( b ) , ; \\ 0 & otherwise .\end{matrix} \\ \text{?} \text{indicates text missing or illegible when filed}$$

The resulting rate in bits/sec for user uεŨ_{c} is

$${\hat{r}}_{u} = {\sum }_{b = 1}^{B} {\hat{t}}_{u , c}^{( \hat{G} )} ( b ) {R}_{u , c}^{( \hat{G} )} ( b ) .$$

A one-dimensional optimization may then be determined (at 615). Some embodiments may determine (at 615) the one-dimensional optimization by identifying a point on a line joining the current candidate solution ({\tilde{y}^{(G)}},{\tilde{t}_{u,c}^{(G)}(b)},{\tilde{r}ᵤ}) and the linear-program solution ({ŷ^{(G)}},{\hat{t}_{u,c}^{(G)}(b)},{\hat{r}ᵤ}) that maximizes the objective function. The point on the line may be determined by the condition:

$${α}^{*} = {arg max}_{α ∈ [ 0 , 1 ]} {\sum }_{u ∈ U} {F}_{u} ( ( 1 - α ) {\ddot{r}}_{u} + α {\hat{ r}}_{u} ) .$$

Solutions to this formula can be found by a simple binary or golden-section search in some embodiments.

The candidate solution can then be updated (at 520) to correspond to the solution determined (at 515) using the one-dimensional optimization. For example, for each cell group GεΓ, cell cεG, user uεU, and sub-band bε{1,2, . . . , B}, the candidate solution may be updated (at 520) to:

\tilde{y}^{(G)}←(1−α*)\tilde{y}^{(G)}+α*ŷ^{(G)},

\tilde{t}_{u,c}^{(G)}(b)←(1−α*)\tilde{t}_{u,c}^{(G)}(b)+α*\hat{t}_{u,c}^{(G)}(b),

\tilde{r}ᵤ←(1−α*)\tilde{r}ᵤ+α*\hat{r}ᵤ.

The method 600 may then determine (at 625) whether the solution has converged. Some embodiments may determine (at 625) that the solution has converged once a* is below a suitably chosen threshold, e.g., if α*<10⁻³. The method 600 may end (at 630) when the solution has converged. Otherwise, the iterative process may continue by maximizing (at 610) the first order approximation of the objective function using the updated values.

Embodiments of the techniques described herein have a number of advantages over the conventional brute force approach. For example, embodiments of the iterative algorithm described herein may adapt naturally and dynamically to changing system parameters such as the density or distribution of picocells or user equipment, the relative transmission powers of the picocells and macrocells, and the like. Embodiments of the techniques described herein may achieve these advantages without requiring extensive off-line simulations to estimate the bias values for inter-cell load-balancing or the time domain partitioning for inter-cell interference coordination.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be a non-transitory storage medium, magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method, comprising:
partitioning cells into groups that comprise different subsets of the cells;
iteratively repeating, until a convergence criterion is satisfied, steps comprising:
determining one or more associations of user equipment to one or more of the cells for a previously determined allocation of resources to the groups; and
determining an allocation of resources to the groups for a previously determined association of user equipment to the cells.

2. The method of claim 1, wherein determining the allocation of the resources to the groups comprises determining time intervals during which cells in the groups actively transmit on a downlink.

3. The method of claim 1, wherein partitioning the cells comprises partitioning a plurality of cells comprising one or more macrocells and one or more picocells overlying the coverage area of the macrocells.

4. The method of claim 3, wherein partitioning the plurality of cells comprises partitioning the plurality of cells into a first group comprising the macrocells and picocells and a second group comprising the picocells but not the macrocells.

5. The method of claim 1, wherein determining the one or more associations of user equipment to one or more cells comprises assigning user equipment to one of the cells based on a cell utility function that is determined based on the previously determined allocation of resources to the groups.

6. The method of claim 1, wherein determining the allocation of resources to the groups comprises determining a candidate allocation of resources that maximizes a first order approximation of an objective function determined based on the previously determined allocation of resources to the groups.

7. The method of claim 6, wherein determining the allocation of resources comprises determining the allocation of resources based on the candidate allocation of resources and the previously determined allocation of resources.

8. The method of claim 1, further comprising determining whether the convergence criterion is satisfied based on a value of an objective function determined for the association of user equipment to the groups and the resource allocation determined during the current iteration.

9. The method of claim 8, further comprising providing an indication of the association of user equipment to the groups and the resource allocation to the plurality of cells in response to the convergence criterion being satisfied.

10. An apparatus, comprising:
a controller configured to partition cells into groups that comprise different subsets of the cells,
wherein the controller is configured to iteratively repeat, until a convergence criterion is satisfied, steps comprising:
determining one or more associations of user equipment to one or more of the cells for a previously determined allocation of resources to the groups; and
determining an allocation of resources to the groups for a previously determined association of user equipment to the cells.

11. The apparatus of claim 10, wherein the controller is configured to determine time intervals during which cells in the groups actively transmit on a downlink.

12. The apparatus of claim 10, wherein the controller is configured to partition a plurality of cells comprising one or more macrocells and one or more picocells overlying the coverage area of the macrocells.

13. The apparatus of claim 12, wherein the controller is configured to partition the plurality of cells into a first group comprising the macrocells and picocells and a second group comprising the picocells but not the macrocells.

14. The apparatus of claim 10, wherein the controller is configured to determine the one or more associations of user equipment to one or more cells by assigning user equipment to one of the cells based on a cell utility function that is determined based on the previously determined allocation of resources to the groups.

15. The apparatus of claim 10, wherein the controller is configured to determine the allocation of resources to the groups by determining a candidate allocation of resources that maximizes a first order approximation of an objective function determined based on the previously determined allocation of resources to the groups.

16. The apparatus of claim 15, wherein the controller is configured to determine the allocation of resources based on the candidate allocation of resources and the previously determined allocation of resources.

17. The apparatus of claim 10, wherein the controller is configured to determine whether the convergence criterion is satisfied based on a value of an objective function determined for the association of user equipment to the groups and the resource allocation determined during the current iteration.

18. The apparatus of claim 17, wherein the controller is configured to provide an indication of the association of user equipment to the groups and the resource allocation to the cells in response to the convergence criterion being satisfied.

19. A non-transitory computer-readable storage medium encoded with instructions that, when executed by a processing device, adapt the processing device to perform a method, the method comprising:
partitioning cells into groups that comprise different subsets of the cells;
iteratively repeating, until a convergence criterion is satisfied, steps comprising:
determining one or more associations of user equipment to one or more of the cells for a previously determined allocation of resources to the groups; and
determining an allocation of resources to the groups for a previously determined association of user equipment to the cells.

20. The non-transitory computer-readable storage medium of claim 19, encoded with instructions that, when executed by a processing device, adapt the processing device to perform a method comprising providing an indication of the association of user equipment to the groups and the resource allocation to the cells in response to the convergence criterion being satisfied.
